(19) United States
(12) Patent Application Publication
(10) Pub. No.: US 2008/0308285 A1
(43) Pub. Date: Dec. 18, 2008

(54) Corrosion resistant sprinklers, nozzles, and related fire protection components and systems

(75) Inventors: Paul P. Su, East Setauket, NY (US); John C. Harrington, Medfield, MA (US)

Correspondence Address: VENABLE LLP, P.O. BOX 34385, WASHINGTON, DC, 20043-9998, US

(73) Assignee: FM Global Technologies, LLC, Johnston, RI (US)

(21) Appl. No.: 12/000,060

(22) Filed: Dec. 7, 2007

Related U.S. Application Data
(60) Provisional application No. 60/878,067, filed on Jan. 3, 2007.

(51) Int. Cl. A62C 37/08

(52) U.S. Cl. 169/37; 239/522

(57) ABSTRACT

A frame of a sprinkler or nozzle for use in a corrosive service environment. The frame includes a corrosion resistant metal having a passive oxide film that is chemically stable in the service environment. Alternatively, the frame includes a polymer that is inert in the service environment.

### CROSS-REFERENCE TO RELATED APPLICATIONS

This patent application claims priority under 35 U.S.C. § 119 to co-pending U.S. Provisional Application No. 60/878,067, filed on Jan. 3, 2007, the entire content of which is incorporated herein by reference.

### TECHNICAL FIELD

This invention relates to corrosion resistant sprinklers, nozzles, and related fire protection components and systems.

### BACKGROUND

Many industrial facilities, such as large metallurgical smelters, steel industry pickling lines, semiconductor fabrication facilities, pulp and paper plants, inorganic chemical facilities, and power generation plants, generate extremely corrosive exhaust fumes, smoke, and particles during their operational processes. Various ductwork systems can be employed to remove or filter these hazardous wastes from the facilities. The ductwork systems are typically fabricated from combustible plastics such as polypropylene, chlorinated polyvinyl chloride, and fiberglass reinforced plastic. The ducts can be up to twelve feet in diameter, and can be hundreds of feet long, with various interconnecting vessels. Loss of a ductwork system due to fire can result in total shutdown of the plant for an extended period of time, and can lead to sizeable losses.

The environment inside the ductwork systems is typically extremely corrosive. High concentrations of inorganic acids, such as sulfuric, nitric, and hydrochloric acids, are often present in the ducts. In addition, the temperature inside the ducts may be very high, sometimes 100° C. or higher, and abrasive particles, such as metal, dust, and ash, may pass through the ducts at a high velocity, for example 40 miles/hour, or more. Thus, the environment inside the ducts can rapidly corrode or otherwise damage metallic structures, such as fire protection components (e.g., sprinklers, or nozzles). The following table lists typical conditions within some extremely corrosive environments of interest:

TABLE 1
Typical Conditions Within Some Extremely Corrosive Environments

| | |
|---|---|
| Temperature | ≈ 20° C. tto over 100° C. |
| Acids/Concentration/pH | HCl, HF, H₂SO₄, HNO₃/from ppm to %/ |
| | pH < 2 |
| Gases/Concentration | SO₂, SO₃, CO₂, NOₓ, Cl₂, F₂/from ppm to % |
| Particle Composition | Cu, Fe, Pb, Zn, As, Sb, Ca, Hg, Ni (usually as |
| | oxides or salts) |
| Condensation | Saturated with moisture droplets and wet/dry |
| | cycle |
| Velocity | can be over 40 miles/hour |

Several attempts have been made to place sprinklers within ductwork systems containing extremely corrosive environments. For example, wax-coated sprinklers, plastic-coated sprinklers, lead-coated sprinklers, sprinklers covered with plastic bags, 316L stainless steel sprinklers, and sprinklers coated with a thin layer of Teflon have been tried in the industry. These conventional sprinklers will sometimes stand up in mildly corrosive environments. However, limited success has been achieved with these types of sprinklers in more corrosive environments, and they have typically corroded to the point of inoperability within a short period of time, sometimes in less than a month. Therefore, for the most part, the prior art has been limited to fire protection systems located on the exterior of ductwork systems containing extremely corrosive environments. These external systems provide less fire protection when compared to internal systems.

Therefore, there remains a need in the art for sprinklers, nozzles, and related fire protection components that can adequately withstand extremely-corrosive environments, such as those within ductwork systems, or those within certain extremely-corrosive process areas.

### SUMMARY

According to an embodiment, a frame of a sprinkler or nozzle for use in a corrosive service environment comprises a corrosion resistant metal having a passive oxide film that is chemically stable in the service environment.

According to another embodiment, a frame of a sprinkler or nozzle for use in a corrosive service environment comprises a corrosion resistant polymer that is inert in the service environment.

According to other embodiments, sprinklers and nozzles comprise the frame in addition to other components constructed from corrosion resistant materials.

Further objectives and advantages, as well as the structure and function of preferred embodiments, will become apparent from a consideration of the description, drawings, and examples.

### BRIEF DESCRIPTION OF THE DRAWINGS

The foregoing and other features and advantages of the invention will be apparent from the following, more particular description, as illustrated in the accompanying drawings wherein like reference numbers generally indicate identical, functionally similar, and/or structurally similar elements.

FIG. 1 is a front perspective view of a corrosion resistant sprinkler;

FIG. 2 is a schematic view of an installation of the sprinkler of FIG. 1 in a duct;

FIG. 3 is a front view of a corrosion resistant nozzle; and

FIG. 4 is a side view of the nozzle of FIG. 3.

### DETAILED DESCRIPTION

Embodiments of the invention are discussed in detail below. In describing embodiments, specific terminology is employed for the sake of clarity. However, the invention is not intended to be limited to the specific terminology so selected. While specific embodiments are discussed, it should be understood that this is done for illustration purposes only. A person skilled in the relevant art will recognize that other components and configurations can be used without departing from the spirit and scope of the invention. All references cited herein are incorporated by reference as if each had been individually incorporated.

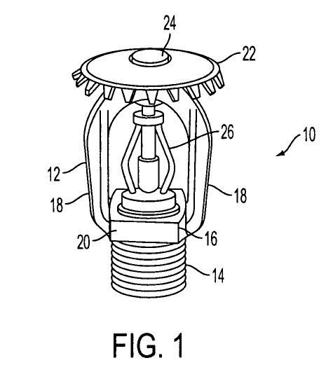

Referring to FIG. 1, shown is an embodiment of a corrosion resistant sprinkler 10 for suppressing fires. Sprinkler 10 can have a generally conventional configuration, and can include, for example, an open frame 12 including a hollow, threaded pipe fitting 14 defining a waterway, a seating surface 16, and a pair of spaced-apart arms 18 extending upward from the pipe fitting 14 and eventually joining one another, for example, in the shape of an arc. Wrench flats 20 can be provided on the frame 12, for example, adjacent to the seating surface 16. All or some of the frame 12 (e.g., pipe fitting 14, seating surface 16, arms 18, wrench flats 20, and/or any additional components) can be of unitary construction, or alternatively, can be formed of individual parts that are joined together.

Sprinkler 10 can also include a deflector 22 attached to the frame 12, for example, by a compression screw 24 that extends into the frame at the junction of the arms 18. Sprinkler 10 can be of the pendant, recessed pendant, upright, or other known configuration.

Still referring to FIG. 1, sprinkler 10 can include a trigger assembly 26 that opens at a predetermined temperature, and allows water, foam, or other fire retardant substances to eject from the waterway in pipe fitting 14. In the embodiment of FIG. 1, the trigger assembly 26 includes a fusible element of the center-strut variety, however, other types of fusible elements can be used instead, such as glass-bulb, quartzoid-type, or other known types of fusible elements.

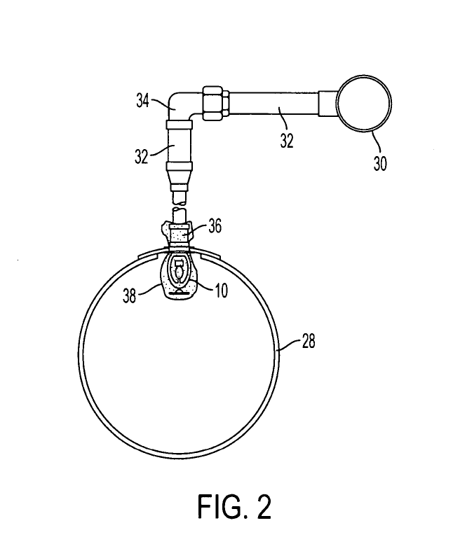

Referring to FIG. 2, a partial representation of an installation of sprinkler 10 in a duct 28 is shown. Duct 28 may be fabricated from plastics such as polypropylene, chlorinated polyvinyl chloride, and fiberglass reinforced plastic, although other materials, including metals, etc., are also possible. Although not shown to scale, duct 28 may be up to twelve feet in diameter, and may be hundreds of feet long. Multiple sprinklers can be installed in the duct 28. The sprinkler 10 can be connected to a submain 30, which supplies water, foam, or other fire retardant substances to one or more sprinklers. The connection to submain 30 can be facilitated through one or more sections of pipe 32, elbows 34, couplings 36, and/or other structures known in the art. In the embodiment shown, the sprinkler 10 is encased in one or more polyethylene bags 38 to protect the sprinkler 10 from the corrosive environment within the duct 28. However, depending on the specific construction of the sprinkler 10, and its resultant corrosion resistant properties, the polyethylene bag(s) may not be necessary. Additionally, there are certain highly corrosive environments where the polyethylene bags alone may not provide sufficient corrosion protection for the sprinkler 10. The installation of sprinkler 10 shown in FIG. 2 is for illustrative purposes only. One of ordinary skill in the art will appreciate that any number of other installations of sprinkler 10 are also contemplated. For example, depending on the size and configuration of the duct 28, one or more sprinklers 10 can be located at the top of the duct (12 o'clock, as shown in FIG. 2), at the bottom (6 o'clock), at the sides (3 and 9 o'clock), and/or at any other position or combination of positions around the circumference of the duct 28.

Duct 28 may enclose an extremely-corrosive environment, such as one of those described in the Background section. As a result, some or all of the component parts of sprinkler 10 and/or the components necessary for its installation, can be constructed at least in part from materials, and/or have coatings, that are adequately resistant to extremely-corrosive environments. Further details regarding these aspects of the sprinkler and related components will be described in more detail below.

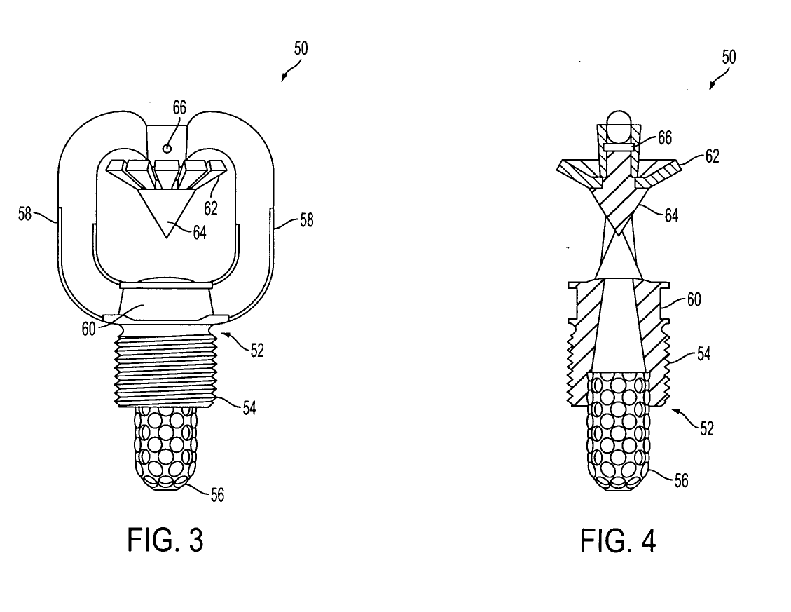

Referring to FIGS. 3 and 4, an embodiment of a corrosion resistant nozzle 50 for suppressing fires is shown. As will be described in more detail below, nozzle 50 can be of the open (non-automatic), directional spray type, and can include an external deflector, however, other configurations are possible. As shown in FIGS. 3 and 4, nozzle 50 can include an open frame 52 including a hollow, threaded pipe fitting 54 defining a waterway, and a pair of spaced-apart arms 58 extending upward from the pipe fitting 54 and eventually joining one another, for example, in the shape of an arc. Wrench flats 60 can be provided on the frame 52 to facilitate installation of the nozzle 50 into a fire protection system. A strainer 56 can be located at the entrance to the waterway in order to strain undesirable particles from the supply of water or other fire-protection substance. All or some of the frame 52 (e.g., pipe fitting 54, arms 58, wrench flats 60, and/or any additional components, such as the strainer 56) can be of unitary construction, or alternatively, can be formed of individual parts that are joined together.

Still referring to FIGS. 3 and 4, nozzle 50 can also include a deflector 62 and/or splitter 64 located opposite from where the fluid flow exits the waterway, for example, in order to control the spray angle of the water or other fire-protection substance. A portion of splitter 64 can extend through a bore in the frame 52, for example, at the junction of the arms 58, and can be secured therein using a pin 66 or other known fastener. Deflector 62 can be mounted around a portion of splitter 64. One of ordinary skill in the art will appreciate that the embodiment of nozzle 50 is shown for illustrative purposes only, and is non-limiting. Therefore, one of ordinary skill in the art will appreciate that any number of other types of nozzles can alternatively be implemented with the present invention.

Nozzle 50 can be installed in a ductwork system, similar to that described above in connection with the sprinkler 10. The nozzle 50 can be part of a fire protection system that includes some form of a heat detection system utilized to activate the system, as will be known to one of ordinary skill in the art. The ductwork system may enclose an extremely-corrosive environment, such as those described above in the Background section. As will be discussed in more detail below, some or all of the component parts of nozzle 50 and/or the associated components necessary for its installation, can be constructed at least in part from materials, and/or have coatings, that are adequately resistant to certain extremely-corrosive environments.

In order to improve the corrosion resistant properties of nozzles, sprinklers, and related components, such as those described above, all or part of the nozzles, sprinklers, and related components can be formed from, or coated with, certain materials that exhibit adequate resistance to corrosion in certain extremely-corrosive environments, such as those described in the Background section and listed in Table A. Through both laboratory and field testing, both of which are described in detail in the “Examples” section, metals and polymers suitable for use in making nozzles, sprinklers, etc., were identified that exhibit satisfactory resistance to corrosion in certain extremely-corrosive environments. In the case of metals, the suitable materials may exhibit the property that their oxide film on the surface (“passive oxide film”) is chemically stable in the service environment. In the case of suitable polymers, they may exhibit the property of being substantially inert in the service environment. Since the service environment may be different from application to application, certain materials may be better suited for specific applications than others. However, C22, C276, C2000, G30 and I686 alloys (listed in Table B, below) all appear to exhibit strong resistance to corrosion in extremely-corrosive environments of interest, such as sulfuric acid environments.

Fluoropolymer based polymers such as polytetrafluoroethylene (PTFE), ethylene-chlorotrifluoroethylene (ECTFE, Halar), ethylene-tetrafluoroethylene (ETFE), polyvinylidene fluoride (PVDF, Kynar), perfluoralkoxy (PFA), and fluorinated ethylene propylene (FEP) also appear to exhibit strong resistance to corrosion in certain extremely-corrosive environments of interest.

According to an embodiment, all or part of a sprinkler, nozzle, or related component can be constructed from a corrosion resistant metal, for example, an alloy having a passive oxide film that is chemically stable in the intended service environment. With respect to sprinklers, the frame 12, deflector 22, compression screw 24, and/or parts of the trigger assembly 26 can be constructed from such a corrosion resistant alloy. For example, when used in sulfuric acid-type environments, these components would be formed from C22, C276, C2000, G30, or I686 alloy, or other alloys found to provide adequate corrosion resistance. These other alloys would be expected to have at least some of the common metal components of C22, C276, C2000, G30, or I686 alloy listed in Table B, below. For example, Nickel-Chromium-Molybdenum (Ni—Cr—Mo) alloys are generally considered to be highly resistant to general corrosion, localized corrosion, and environmentally assisted cracking. The sprinklers, nozzles, and related components can be constructed from the corrosion resistant metals using conventional manufacturing techniques. Any related sprinkler system components that may be exposed to the extremely-corrosive environment (e.g., that protrude into the interior of abduct or flume, etc.) such as pipe 32, elbow 34, coupling 36, etc., can also be formed from the same or similar corrosion resistant metals, again, using conventional manufacturing techniques.

In addition, all or part of a nozzle (e.g., the frame 52, strainer 56, deflector 62, splitter 64, and/or pin 66) and nozzle-related components (e.g., pipes and couplings, etc.) can be formed from a corrosion resistant metal, such as an alloy having a passive oxide film that is chemically stable in the intended service environment (e.g., C22, C276, C2000, G30, or I686 alloy). The sprinkler system components can be manufactured from the corrosion resistant metals using conventional manufacturing techniques.

To further reduce corrosion in highly aggressive corrosive environments, various coatings or coating systems may be applied over a metal or other base substrate to extend the service life of the structure. The coating can act as a barrier layer to protect the underlying substrate from contacting corrosive chemicals in the service environment. Some criteria for a successful coating or coating system in a highly-corrosive environment may include, for example, a stable substrate, an inert coating formulation, and proper application of the coating to the substrate, so as to reduce coating defects. Fluoropolymer coatings may be good candidates for protecting a substrate from corrosion because of strong interatomic bonds between carbon and fluorine atoms. Also, fluoropolymer's carbon chain is shielded by fluorine atoms, and its high molecular weight due to having a long carbon chain acts as a good barrier layer against water and aggressive ions. Further, polymerized fluoropolymer coatings are often inert in an HF/HNO₃ mixed acid environment. As a result, fluoropolymer coatings may increase the corrosion resistance of a structure in highly corrosive environments, such as a HF/HNO₃ duct environment.

According to another embodiment, the corrosion resistant metal can be coated, completely or partially, in a corrosion resistant polymer, such as fluoropolymer based polymers. According to one embodiment, the frames 12, 52, or other parts, can be formed from a corrosion resistant alloy, such as C22, C276, C2000, G30, or I686 alloy, coated in a thick layer (e.g., greater than 0.02 inches) of a fluoropolymer based polymer, such as PTFE, ECTFE, ETFE, PVDF, PFA, or FEP. Alternatively, an epoxy-type coating can be used. In the event that the extremely-corrosive environment diffuses through the outer coating, the underlying alloy itself can still resist corrosion. The coating can be applied to the underlying metal component(s) using conventional techniques. According to an embodiment, alloy C22 may be coated with ECTFE or ETFE, however, other combinations of the above-referenced substrates and coatings are possible.

According to another embodiment, the sprinklers, nozzles, and related components can be formed from cheaper, conventional metals that exhibit lower corrosion resistance (e.g., stainless steels, brass, bronze, etc.), and have a coating of a corrosion resistant protective layer. For example, the underlying material can be coated with a corrosion resistant alloy (e.g., an alloy having a passive oxide film that is chemically stable in the intended service environment, such as C22, C276, C2000, G30, or I686 alloy). Alternatively, the underlying material can be coated with a corrosion resistant polymer (e.g., one that is substantially inert in the service environment, such as fluoropolymer based polymers like PTFE, ECTFE, ETFE, PVDF, PFA, or FEP) or an epoxy-type coating. These embodiments may have the benefit of reducing the overall cost of the sprinklers, nozzles, and related components, by limiting the use of expensive, highly corrosion resistant materials to the external surfaces where they are most needed, and maximizing the use of less expensive, more conventional materials, such as stainless steel, brass, bronze, etc. Referring, for example, to FIG. 1, the frame 12, deflector 22, compression screw 24, and/or part of the trigger assembly 26 can be formed from, e.g., stainless steel coated with PTFE, ECTFE, ETFE, PVDF, PFA, or FEP, or an epoxy-type coating. Alternatively, they can be formed from stainless steel coated with C22, C276, C2000, G30, or I686 alloy. The same principles apply equally to the nozzle of FIGS. 3 and 4, as well as related system components, and need not be described further herein. The corrosion resistant coatings can be applied to the underlying component(s) using conventional techniques.

According to yet another embodiment, some or all of the parts of sprinklers, nozzles, and related components can be formed entirely from a corrosion resistant polymers that is substantially inert in the service environment (referred to herein generally as a “structural polymer”). For example, with reference to FIGS. 1 and 2, the sprinkler frame 12, deflector 22, compression screw 24, and/or parts of trigger assembly 26, as well as the pipes 32, couplings 36, elbows 34, and/or other related components can be constructed from a polymer that is substantially inert in the intended service environment, such as a fluoropolymer based polymer (e.g., PTFE, ECTFE, ETFE, PVDF, PFA, or FEP), or an epoxy-type coating. The same principle can also be applied to the nozzles. For example, referring to FIGS. 3 and 4, the nozzle's frame 52, strainer 56, deflector 62, splitter 64, and/or pin 66 can be constructed from a polymer that is substantially inert in the intended service environment, such as those mentioned above. The sprinklers, nozzles, etc., can be constructed from corrosion resistant polymers using conventional manufacturing techniques. According to an embodiment, Teflon can be used as a structural polymer.

### EXAMPLE 1

### Identifying Suitable Alloys

As discussed previously, it is currently believed that only limited types of materials can survive the extremely-corrosive industrial environments of interest, such as those described in the Background section and characterized in Table A. In order to identify some materials that may be suitable for the environments of interest, both laboratory and field experiments were conducted to identify suitable alloys. Twelve alloys, including high nickel alloys and stainless steel alloys, were selected for evaluation. The chemical compositions of these alloys and their Unified Numbering System (UNS) numbers are provided in Table B, below. The alloys used for testing were obtained from Alabama Specialty Products Inc., located at 152 Metal Samples Road, P.O. Box 8, Munford, Ala. 26268.

TABLE B
Tested Alloys-Chemical Compositions (weight %) and UNS Numbers

| Alloy | C276 | C 22 | I686 | CW6M | I625 | 316L | 20Cb-3 | 2205 | 904L | 825 | C2000 | G30 |
|---|---|---|---|---|---|---|---|---|---|---|---|---|
| UNS | N10276 | N06022 | N06686 | N30107 | N06625 | S31603 | N08020 | S31803 | N08904 | N08825 | N06200 | N06030 |
| C | 0.01 | 0.015 | 0.01 | 0.01 | 0.1 | 0.03 | 0.07 | 0.03 | 0.01 | 0.05 | 0.01 | 0.03 |
| Co | 2.5 | 2.5 | | | 1 | | | | | | 5.0 | |
| Cr | 15.5 | 22 | 21 | 19 | 21.5 | 17 | 20 | 22 | 20 | 21.5 | 23 | 29.8 |
| Cu | 0.5 | 0.5 | | | 0.5 | | 3.5 | | 1.5 | 2.3 | 1.6 | 1.7 |
| Fe | 5.5 | 3 | 5.0 | 1 | 5 | 63 | 37 | 66 | 43 | 22.0 | 3 | 15.0 |
| Mn | 1 | 0.5 | 0.75 | 0.59 | 0.5 | 2 | | 2 | 2 | 1.0 | 0.5 | 1.5 |
| Mo | 16 | 13 | 16 | 17.5 | 9 | 2.5 | 2.2 | 3 | 4.5 | 3 | 16 | 5.0 |
| Ni | 57 | 56 | 58 | 61 | 58 | 12 | 34 | 5.5 | 25 | 43 | 59 | 43 |
| P | 0.04 | 0.02 | 0.04 | | 0.015 | 0.045 | 0.045 | 0.03 | 0.045 | | | 0.04 |
| S | 0.03 | 0.02 | 0.02 | | 0.015 | 0.03 | 0.03 | 0.02 | 0.03 | 0.03 | | 0.02 |
| Si | 0.08 | 0.08 | 0.08 | 0.5 | 0.5 | 1 | 1.0 | 1 | 1 | 0.5 | 0.08 | 0.8 |
| Ti | | | 0.02 | | 0.4 | | | | | 0.9 | | |
| V | 0.35 | 0.35 | | | | | | | | | | |
| W | 4 | 3 | 3.9 | | | | | | | | | 2.8 |
| Nb | | | | | 3.5 | | | | | | | 0.9 |

The specimens were made into metal coupons and polished to a 120-grit finish, washed with de-ionized water, and ultrasonically cleaned in acetone. Tests were performed on the metal coupons in both the laboratory and the field.

Crevice Assembly Immersion Tests

Crevice assembly immersion tests were used to study crevice corrosion resistance of the twelve alloys. The metal coupons were assembled into the “multiple crevice assembly” described in ASTM G48-00 (method D). Specifically, each assembly included a Teflon bolt extending through a bore in one of the coupons, and secured therein with a Teflon nut and Teflon segmented washers on both sides of the bore. Each assembly was immersed in a bottle filled with a corrosive test fluid (11.4% H₂SO₄+1.2% HCl+1% FeCl₃+1% CuCl₂), often referred to as “green death solution,” which is known to be a good simulant for flue gas desulphurization. The test fluid was maintained at 75° C. in a water bath for one week. Periodically, after 24, 48, 72 and 168 hours of immersion, the coupons were removed from the bottles, disassembled, cleaned, weighed, and photographed to evaluate their corresponding corrosion properties.

Experimental weight loss data from the crevice assembly tests was converted into a penetration rate per year, which is typically expressed in mils per year (0.001 inches/year). The following formula was used for the conversion: MPY=534 W/DAT, where W is the experimental weight loss in milligrams, D is the metal density in grams per cubic centimeter, A is the area in square inches, T is the exposure time in hours, and 534 is a conversion factor. This can be a good indication of the uniform corrosion rate of the material.

Of the tested materials, the C22 and I686 alloys appeared to exhibit the best corrosion resistance (<1 mpy), and C276 and CW6M appeared to exhibit the next best corrosion resistance (≈1-5 mpy). Currently, corrosion rates greater than ≈5 to 20 mpy are generally considered excessive for corrosion resistant alloys. Much higher corrosion rates (>100 mpy) were observed from the remaining alloys tested.

It is currently believed that in order for corrosion resistant alloys to serve in industrial exhaust systems of interest, uniform corrosion may not be the main failure mechanism. Rather, localized corrosion, such as pitting and crevice corrosion, appear to be the main cause of failure. These types of corrosion constitute the most undesirable failure mechanisms as time-to-failure can be difficult to predict. As shown in Table A, fumes in the industrial exhaust systems of interest can contain strong acids with Cl⁻ and F⁻ ions which are associated with severe localized corrosion.

The local corrosion properties of the coupons were also evaluated by visual inspection following the crevice assembly immersion tests. The occurrence of severe pitting/crevice corrosion after one week of immersion eliminated many of the tested materials. C22, I686, and C276 appeared to be the only materials that did not develop pits after a one-week exposure period.

Electrochemical Tests

Electrochemical testing, including cyclic potentiodynamic polarization (CP) and long-term open circuit potential measurement, were also utilized to study the coupons' corrosion properties. The electrochemical configuration included a Solatron® Model 1287 potentiostat interfaced to a computer using Corrware/Corview software. The testing cell was a Princeton Applied Research® Model K0235 Flat Cell. The cell contained a platinum counter electrode, a silver-silver chloride (SSC) reference electrode, a working electrode (test specimen), and 300 ml of the test fluid (described above). The polarization scan rate was 0.17 mv/s. Each specimen was immersed in the test fluid for one hour prior to the start of the polarization scan. The test fluid was open to air at room temperature.

CP scans of the 316L alloy in flue gas simulant indicated a negative hysteresis loop, which can indicate that the protective oxide film on the surface of 316L is not stable and that 316L is susceptible to pitting/crevice corrosion in the test fluid. However, positive hysteresis loops were observed for C276 in the test fluid, which appears to indicate that the oxide film on the C276 surface is passive (stable) and that C276 is not susceptible to pitting/crevice corrosion in this environment.

The changes in corrosion potential (Ecorr) with time for C22, C276, CW6M, and 316L alloy were measured. They gradually increased from 0.48 Vssc and 0.45 Vssc versus silver/silver chloride reference electrode (SSC) to a nearly steady value of 0.57 Vssc after 50 hours. This appears to indicate the growth of a stable and pit free oxide film on the C22 and C276 surface. However, the OCP (Open Circuit Potential) of 316L appeared to exhibit considerable fluctuation, apparently suggesting active pitting dissolution during the exposure.

The charge integral over the hysteresis was also calculated by integrating the current over time to obtain the quantity of electrons transferred from the metal coupon as a result of the electrochemical reaction (corrosion) during the CP scan. This appears to indicate damage to the protective oxide film with larger numbers suggesting more oxide film damage. Based on the experimental results, C22, CW6M, C276, and I686 appeared to demonstrate the highest resistance to pitting and corrosion.

Field Tests

Based on the crevice assembly immersion tests and the electrochemical tests, four of the materials were selected for field testing under real-world conditions. The four materials selected were C22, C276, I686, and CW6M. Due to the extremely corrosive environments in the ducts, and due to the possibility of fume velocity of up to 40 miles/hour or higher, special test racks were constructed. The test racks were mounted to the duct interior wall with the test coupons attached to the end of the rack and suspended into the central portion of the duct. Ten test racks were assembled and sent to five test sites for long-term exposure evaluation. Of the five test sites, three were pickling facilities, and two were the exhaust duct of a sulfuric acid plant. The test racks were installed in the exhaust ducts. All test racks were retrieved from the test sites for evaluation.

After retrieval from the test sites, the metal coupons were removed from each test rack, cleaned, weighed, and evaluated under optical microscopes and by SEM. The equation MPY=534 W/DAT, discussed previously, was applied to calculate the corrosion rate of the coupons.

Sulfuric acid (H₂SO₄) processing and hydrofluoric acid/nitric acid (HF/HNO₃) pickling were the main processing environments for the five test sites. Depending on the types of alloys to be pickled, different concentrations of acids and/or processing temperatures were in use at the plants to remove scale from the alloys.

Two Weeks Exposure

Two test racks were installed on pickling lines for two weeks. One of the racks was exposed to a pickling tub filled with 20% sulfuric acid (H₂SO₄) and 80% water at ≈96° C. maximum operating temperature. The other test rack was exposed to a pickling tub filled with 10% nitric acid (HNO₃), 5% hydrofluoric acid (HF), and 85% water at ≈60° C. In the sulfuric acid pickling environment, all four alloys (C22, C276, I686, and CW6M) showed very low corrosion rates (<1 mpy). Only CW6M experienced minor pitting corrosion. The results appeared to indicate that the oxide films of C22, I686, and C276 were passive in this environment and could survive long-term exposure.

In the nitric acid environment, coupon corrosion rates were higher by orders of magnitude than those in the sulfuric acid environment after the same exposure time. This appeared to indicate that the HF/HNO₃ mixed acid environment was more corrosive to the tested alloys than the H₂SO₄ exposure environment. CW6M was severely pitted with a 32.1 mpy corrosion rate. For I686, the 16.7 mpy corrosion rate was relatively low, but intergranular corrosion was visible. C276 exhibited shallow pits, however, it had a 65 mpy corrosion rate, which was the highest among all four alloys, apparently suggesting a high uniform corrosion rate with less pitting. C22 appeared to display the best corrosion properties with 15.9 mpy corrosion rate and relatively less pitting.

The C276 alloy coupon from the nitric acid environment developed a green corrosion product on its surface. This green corrosion product was analyzed using the X-ray powder diffraction technique. The NiCrF₅-7H₂O complex was identified as the main component. This appeared to indicate that the passive oxide film (Cr, Mo oxides) on the C276 alloy was attacked by fluoride ions in the HF/HNO₃ environment, and could not protect the metal from corrosion.

Four Weeks Exposure

A second set of test racks was installed on an annealing and pickling line for four weeks. One test rack was exposed to a pickling tub filled with 10-20% sulfuric acid at =93° C. Another test rack was exposed to a mixed acids pickling tub with 24% hydrofluoric acid plus 8-10% nitric acid at ≈82° C. maximum processing temperature. In the sulfuric acid pickling environment, all four alloys displayed low corrosion rates with only CW6M experiencing pitting corrosion. In the HF/HNO₃ environment, pitting corrosion was apparent for all four alloys. Most of the coupons' surface had reacted with the environment, and only C22 alloy retained polishing grooves visible on its surface. The corrosion rates were high for C276 and CW6M, up to 125 mpy and 108 mpy, respectively. C22 and I686 had 27.5 mpy and 58.2 mpy corrosion rates, respectively.

Ten Weeks Exposure

The third set of test racks was installed in acid pickling ductwork for approximately ten weeks. One test rack was installed in the ductwork of a pickling tub filled with 25% sulfuric acid at ≈52° C. The other test rack was exposed to a mixed acids pickling tub with 0.54% hydrofluoric acid plus 6-18% nitric acid at near ambient temperature. For the sulfuric acid exposure, all four alloys appeared to exhibit outstanding corrosion resistance (<1 mpy). For the HF/HNO₃ environment, although pitting corrosion was observed for all four alloys, C22 and I686 appeared to experience relatively low corrosion rates, 3.81 mpy and 5.22 mpy, respectively, in comparison to the first and second HF/HNO₃ pickling atmospheres (15.9 mpy and 16.7 mpy for “Two Weeks Exposure” site) and (27.5 and 58.2 mpy for “Four Weeks Exposure” site). The corrosion rate difference may be caused by the different processing temperature for each facility, with lower ambient temperature corresponding to lower corrosion rate. For example, the third pickling bath was at ambient temperature instead of 60° C. and 82° C. for the first and second sites, respectively.

Ten Months Exposure

The fourth set of test racks was installed inside the sulfuric acid processing ductwork of a metallurgy plant for ten months. Pitting corrosion was observed for all four alloys, C22 and I686 experienced low corrosion rates of 3.29 mpy and 4.03 mpy, respectively. Also, C276 experienced a higher 12.9 mpy corrosion rate. Additionally, both I686 and C276 exhibited signs of erosion corrosion on the metal surface, and CW6M coupons were severely corroded with pitting corrosion.

The fifth set of test racks was installed in the exhaust duct of a sulfuric acid processing plant for ten months. After the ten months, the CW6M was severely pitted and had a 9.89 mpy corrosion rate; also stress corrosion cracks were visible under the SEM. The I686 exhibited a 4.03 mpy corrosion rate, which was relatively low, but pitting corrosion was visible under the SEM. The C276 exhibited shallow pits, but had a 12.9 mpy corrosion rate—the highest among the four alloys—suggesting a high uniform corrosion rate with less pitting. The C22 displayed the best corrosion properties with a 3.29 mpy corrosion rate; some pitting was visible under the SEM.

Surface and Materials Characterization

A Zeiss® metallograph was used to investigate surface morphology of the coupons and produce photographs of the corroded coupons. A scanning electron microscope with energy dispersive X-ray spectrometry (SEM/EDS) was also used to analyze the exposed coupons. This equipment provides highly magnified images and chemical analysis of local areas. In addition, corrosion products on the metal coupon surfaces were removed and analyzed with Philips® X-ray powder diffraction equipment. This technique can identify corrosion compound through characterizing the X-ray diffraction patterns of the material.

As mentioned previously, localized corrosion (especially pitting corrosion) appears to be the main corrosion mechanism for alloys in the exhaust fume environments of interest. The pitting damage on some of the exposed coupons was estimated by measuring the average pit diameter, pit number density, and maximum observed pit depth by the Zeiss® metallograph with image analysis software. Pit depth was determined by the following procedure: the top and bottom of a pit were focused and the depth readings on the fine-focus knob were recorded; then the difference between the two depth readings was calculated to approximate the pit depth.

For the sulfuric acid environment, no pitting corrosion attack was found from field coupons of C22, I686, and C276. This appears to be a good indication that the oxide film on these three alloys was stable and can survive long-term exposure to this environment. Pitting corrosion was observed for CW6M coupons exposed to some of the pickling environments with pitting density of 2.4×10⁷ and 3.4×10⁸ pits per m².

As for the three HF/HFNO₃ pickling environments, coupons of all four alloys developed different degrees of pitting corrosion. This appears to indicate that the passive oxide film on these alloys may not be stable in the HF/HNO₃ atmosphere, and the breakdown of the passive oxide film initiated localized corrosion in the exposed coupons. CW6M was extensively corroded, with ≈80 μm measured pit depth after four weeks of exposure. C276 exhibited shallow pits on its surface, however, it had a very high uniform corrosion rate, reaching 125 mpy. I686 was heavily corroded with pitting and intergranular corrosion. C22 gave the best performance with respect to uniform corrosion, yet, a good number of pits were still observed on its surface after the exposure.

Test Results

At present, the laboratory and field testing appears to indicate that, for the relatively hot (50-93° C.), sulfuric acid environment, C22 and I686 demonstrated very low uniform corrosion rates which were smaller than 1 mil penetration per year (mpy) with no pitting corrosion attack. C276 experienced a uniform corrosion rate of up to 1.61 mpy with no pitting attack. CW6M exhibited a higher uniform corrosion rate, and was more susceptible to pitting, however, it still appeared to be suitable for use in the hot sulfuric acid environment.

For the nitric/hydrofluoric acid environment, all four alloys developed some pitting corrosion, however, C22 appeared to give the best performance with a corrosion rate of 27.5 mpy. Alloy C276 experienced higher mass loss with a uniform corrosion rate of up to 125 mpy after 4 weeks in the HF/HNO₃ pickling environment; under the same environment, I686 appeared to exhibit severe pitting and intergranular corrosion. CW6M appeared to be extensively corroded with a uniform corrosion rate of up to 108 mpy.

Alloy C22, I686, and C276 appeared to perform especially well in environments like flue gas desulphurization ducts, smelter exhaust systems, and sulfuric acid plant ducts. In the HF/HNO₃, environment, C22 ranked first and I686 ranked second. Stainless Steels 316L, 2205, 904L, 20Cb-3, and high nickel alloy 625 all experienced severe localized corrosion in all of the tested corrosive industrial exhaust environments.

At present, alloys C2000 and G30 appear to exhibit similar levels of corrosion resistance as C22 and I686.

### EXAMPLE 2

### Identifying Suitable Coatings

It is currently believed that there are limited types of coatings that can survive the extremely-corrosive industrial environments of interest, such as the environments described in the Background section and characterized in Table A, especially for the environment inside the exhaust ducts of a HF/HNO₃ pickling plant. Four types of coatings were selected for evaluation: PFA (a fully fluorinated copolymer of tetra fluoroethylene and perfluorovinyl ether), ECTFE (a partially fluorinated copolymer of ethylene and chlorotrifluoroethylene modified with improved abrasion resistance), ETFE (a partially fluorinated copolymer of ethylene and tetrafluoroethylene), and epoxy (a commonly used organic coating). Structural PTFE plate was also selected for testing in the HF/HNO₃ pickling environment. Chemical structures and compositions for these coating materials are given in Table C, below. The coatings were applied by the electrostatic powder spray method to increase coating thickness and to improve adhesion between the substrate and coating interface for the purpose of improving corrosion/erosion resistance of the substrate. The substrate used for these tests was C22 alloy (UNS No. NO6022), however, other materials can alternatively be used with the coatings. The C22 substrate used for testing was obtained from Alabama Specialty Products Inc., located at 152 Metal Samples Road, P.O. Box 8, Munford, Ala. 26268. The coatings used for testing were obtained from PCM Company, located at 1431 Ferry Avenue, Camden, N.J. 08104. Ni/Teflon coated coupons provided by Victaulic® were also tested for their stability.

TABLE C
Tested Coating Materials - Chemical Structures and Compositions

| Material | Chemical Structure | Basic Composition | Application method |
|---|---|---|---|
| ETFE | Ethylene-Tetrafluoroethylene | 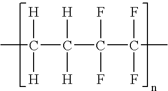 | Electrostatic Spray Powder Coating |
| PFA | Perfluoralkoxy (copolymer of Tetrafluoroethylene and Perfluorovinyl ether) | 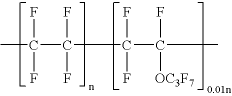 | |
| ECTFE | Ethylene-Chlorotrifluoroethylene | 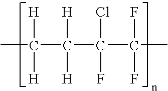 | |
| Epoxy | Epoxide | | |

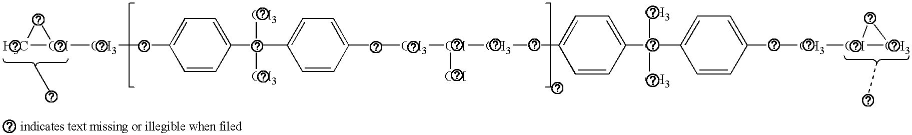

Laboratory Immersion Tests

Laboratory immersion tests were performed on the coated coupons (ECTFE, ETFE, PFA, and epoxy coatings). The test fluid commonly known as “green death solution,” having the composition of 11.4% H₂SO₄+1.2% HCl+1% FeCl₃+1% CuCl₂ was used. Each coupon measured approximately ¾″×2″×⅛″. Each coupon was immersed in a bottle filled with approximately 300 ml of the test solution and maintained at 75° C. in a water bath for three weeks, except for the Ni/Teflon coated coupons, which were only tested for three days. The epoxy and nickel/Teflon coated coupons exhibited clear coating delamination, however, the ECTFE, ETFE, and PFA coated coupons did not show any significant degradation after three weeks of immersion testing.

Electrochemical Impedance Spectroscopy Testing

Candidate coatings were subjected to Electrochemical Impedance Spectroscopy (EIS) scans to probe their long term stability in the testing fluid. The electrochemical configuration used for the testing consisted of a Solartron® Model 1287 potentiostat interfaced to a computer using Zplot/Zview® software. The testing cell used was a Princeton Applied Research® Model K0235 Flat Cell. The cell contained a platinum counter electrode, a silver-silver chloride (SSC) reference electrode, a working electrode (test specimen), and 300 ml of test solution.

The EIS scans were performed for epoxy coated coupons ranging from new to five weeks of exposure. The scans indicated that new epoxy coated coupons had the highest impedance (Z) value of ≈10¹⁰ ohm/cm² (at 0.1 Hz), and decreased with time to ≈10⁴ ohm/cm² (at 0.1 Hz) after five weeks of exposure. This indicated that ions such as Cl⁻, H⁺, and SO₄²⁻, along with water, had penetrated through the coating toward the C22 substrate, and caused the impedance of the coated coupon to decrease almost six orders of magnitude after five weeks of exposure.

The EIS testing revealed that, after three weeks of exposure, the ECTFE, ETFE, and PFA coatings displayed higher coating resistance [impedance] (≈2×10¹⁰ ohm/cm² at 0.1 Hz) than did the epoxy coating (≈10⁴ to 10⁵ ohm/cm² at 0.1 Hz). Ratings based on visual examination were also obtained from laboratory immersion tests of ECTFE, ETFE, PFA, epoxy, and nickel/Teflon coatings, with the epoxy and nickel/Teflon coated coupons exhibiting coating degradation.

Table D, below, summarizes the laboratory testing for the coated samples. Four coatings, ETFE, PFA, ECTFE, and epoxy were selected for field testing based on the laboratory testing results.

TABLE D
Laboratory Testing Results For Coated Coupons

| | | | Lab Exposure | |
|---|---|---|---|---|
| Sub- | | Average Coating | Coating | |
| strate | Coating | Thickness (mils) | Condition | EIS* (ohm/cm²) |
| C22 | ETFE | 40.4 | a | 1.9 × 10¹⁰ |
| C22 | PFA | 21.8 | a | 2.1 × 10¹⁰ |
| C22 | ECTFE | 31.8 | a | 2.1 × 10¹⁰ |
| C22 | Epoxy | 27.1 | b | 2.7 × 10⁴ |
| 304 | Nickel/Teflon | 0.43 | b | — |
| C22 | Wax | 1.37 | b | 9.9 × 10⁴ |

*EIS Value at 0.1 Hz after three weeks of exposure
“a” = intact coating; “b” = blistering, or delaminating coating

Field Tests

Three real-world metal pickling locations participated in the field tests of the test racks and coupons. The coupons were mounted to test racks constructed from structural PTFE material and sent to three different test sites for field evaluation. The test racks were installed in or close to exhaust duct systems. Four of the test racks were successfully retrieved for analysis after three months of exposure; however, two of the test racks broke loose and were lost after four months of exposure.

Three Months Exposure

Two test racks were installed on a pickling line at the Brackenridge, Pa. location of Allegheny Ludlum for three months. The test racks were exposed to the exhaust from a pickling tub filled with 5% hydrofluoric acid (HF), 10% nitric acid (HNO₃), and 85% water at an operating temperature of up to approximately 71° F. The coupons received from the test racks showed no visible degradation of the ECTFE and ETFE coated coupons; however, blisters (coating degradation) appeared on the PFA and epoxy coated coupon surfaces. For the PFA and epoxy coated coupons, part of the coating was removed and corrosion of the C22 metal substrate was observed.

A scanning electron microscope (SEM) was used to take images of the metal substrates of the coated test coupons after exposure to the HF/HNO₃ pickling environment. No metal corrosion was shown on the metal surface of the ECTFE and ETFE coated coupons. However, corrosion was observed on the coupons with PFA and epoxy coatings, probably due to the delamination (blistering) of the coating. More specifically, sandblasting marks on the metal surface (formed by sandblasting prior to applying the coating) were partially corroded away. The blistering of the PFA and epoxy coatings likely indicates that aggressive fluid contaminants penetrated through the coatings and accumulated underneath them; this can cause the metal substrate to corrode locally.

Fournier Transform Infrared Spectroscopy (FTIR) spectra were taken of the polymer coatings both before and after retrieval of the test racks from the field. The FTIR spectra were used to evaluate each coating's chemical stability in the test environment by comparing the spectra from before and after exposure. The FTIR spectra showed that the ECTFE, ETFE, and PFA coatings exhibited no noticeable changes over the whole 4000 to 500 cm⁻¹ region, apparently indicating that these three coatings were chemically stable in the HF/HNO₃ pickling environment after three months of exposure. In contrast, the FTIR spectra for the epoxy coating showed observable spectra changes over the whole 4000 to 500 cm⁻¹ region. Therefore, based on the FTIR data of the field exposed coupons, the ECTFE, ETFE, and PFA coatings were stable in the HF/HNO₃ pickling environment, but the epoxy coating apparently was not.

A second set of test racks was installed in the acid pickling ductwork for three months at the Midland, Pa. location of Allegheny Ludlum. One test rack was installed in the ductwork of a pickling tub filled with 25% H₂SO₄ at ≈52° C. for three months. The coupons from this test rack showed no visible coating degradation. Another test rack was exposed to a mixed acids pickling tub with 0.5 to 4% hydrofluoric acid plus 6 to 18% nitric acid (HF/HNO₃) at near ambient temperature for three months. The ECTFE and ETFE coatings showed no visible signs of degradation. However, visible blisters were present on the PFA and epoxy coated coupons.

SEM images were, taken of the metal substrate of each coated coupon after exposure to the HF/HNO₃ pickling environment for three months. No metal corrosion was found on the sandblasted metal surface (from sandblasting prior to applying the coating) of the ECTFE and ETFE coated coupons. However, corrosion was observed on the metal substrate of the coupons coated with PFA and epoxy coatings, presumably due to coating delamination (blistering). Specifically, the sandblasting marks on the metal substrates were partially corroded away.

Testing of Structural PTFE Material

The structural PTFE materials used to make each of the test racks were also evaluated by FTIR and SEM techniques prior to the field testing, to evaluate their chemical and microstructure stabilities. No significant changes were found in the FTIR spectra or the surface topography from before and after field exposure. The FTIR spectra of PTFE was almost the same as that of the PFA coating, which is a pure Teflon material.

Test Results

Based on the laboratory and field testing results, it currently appears that ECTFE and ETFE coatings can well protect an underlying base substrate, such as C22 alloy, from corrosion in sulfuric acid exhaust fumes and in nitric/hydrofluoric acid exhaust fumes. Therefore, it is believed that less-expensive substrates, such as 304 or 316L stainless steels coated with ECTFE or ETFE coatings can alternatively be used, for example, to reduce the cost of nozzles and sprinklers, yet still provide a reasonable service life span (e.g., from one to several years) in a highly corrosive environment.

Based on the field tests in the sulfuric acid environment, ECTFE, EFTE, PFA, and epoxy all proved suitable for fire protection equipment, as no significant corrosion was observed for any of these coatings. For the nitric/hydrofluoric acid environment, ECTFE and ETFE, in particular, appear to be suitable coatings. In addition, the structural PTFE materials (i.e., components made primarily or entirely of PTFE) did not evidence any corrosion or degradation after the sulfuric acid and the nitric/hydrofluoric mixed acids field tests. Alloy C22 coated with ECTFE or ETFE coatings performed well in the H₂SO₄ and HF/HNO₃ processing environments, as did the structural PTFE materials.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A frame of a sprinkler or nozzle for use in a corrosive service environment, comprising a corrosion resistant metal having a passive oxide film that is chemically stable in the service environment.

2. The frame of a sprinkler or nozzle of claim 1, wherein the corrosion resistant metal is an alloy selected from the group consisting of C22, C276, C2000, G30, and I686.

3. The frame of a sprinkler or nozzle of claim 1, wherein the frame is constructed substantially throughout from the corrosion resistant metal.

4. The frame of a sprinkler or nozzle of claim 1, further comprising a corrosion resistant coating formed over the corrosion resistant metal.

5. The frame of a sprinkler or nozzle of claim 4, wherein the corrosion resistant coating is a corrosion resistant polymer.

6. The frame of a sprinkler or nozzle of claim 5, wherein the corrosion resistant polymer is a fluoropolymer selected from the group consisting of PTFE, ECTFE, ETFE, PVDF, PFA, and FEP.

7. The frame of a sprinkler or nozzle of claim 4, wherein the corrosion resistant coating is epoxy.

8. The frame of a sprinkler or nozzle of claim 1, further comprising:
a base substrate constructed from a first material; and
a coating of the corrosion resistant metal covering the base substrate;
wherein the first material exhibits lower corrosion resistance than the coating.

9. The frame of a sprinkler or nozzle of claim 8, wherein the first material comprises a metal selected from the group consisting of stainless steel, brass, and bronze.

10. The frame of a sprinkler or nozzle of claim 8, wherein the first material comprises C22 alloy, and the second material comprises at least one of ECTFE or ETFE.

11. The frame of a sprinkler or nozzle of claim 1, wherein the corrosion resistant metal is resistant to corrosion from inorganic acids.

12. A sprinkler comprising the frame of claim 1, further comprising:
one or more sprinkler components attached to the frame, the sprinkler components selected from the group consisting of a deflector, a compression screw, and a trigger assembly;
wherein at least one of the sprinkler components comprises the corrosion resistant metal.

13. A nozzle comprising the frame of claim 1, further comprising:
one or more nozzle components attached to the frame, the nozzle components selected from the group consisting of a strainer, a deflector, a splitter, and a pin;
wherein at least one of the nozzle components comprises the corrosion resistant metal.

14. The frame of a sprinkler or nozzle of claim 1, wherein the corrosion resistant metal comprises Nickel, Chromium, and Molybdenum.

15. A frame of a sprinkler or nozzle for use in a corrosive service environment, comprising a corrosion resistant polymer that is inert in the service environment.

16. The frame of a sprinkler or nozzle of claim 15, wherein the corrosion resistant polymer is a fluoropolymer selected from the group consisting of PTFE, ECTFE, ETFE, PVDF, PFA, and FEP.

17. The frame of a sprinkler or nozzle of claim 15, wherein the frame is constructed substantially throughout from the corrosion resistant polymer.

18. The frame of a sprinkler or nozzle of claim 15, further comprising:
a base substrate constructed from a first material; and
a coating of the corrosion resistant polymer covering the base substrate;
wherein the first material exhibits lower corrosion resistance than the coating.

19. The frame of a sprinkler or nozzle of claim 18, wherein the base substrate comprises a metal selected from the group consisting of stainless steel, brass, and bronze.

20. The frame of a sprinkler or nozzle of claim 15, wherein the corrosion resistant polymer is resistant to corrosion from inorganic acids.

21. A sprinkler comprising the frame of claim 15, further comprising:
one or more sprinkler components attached to the frame, the sprinkler components selected from the group consisting of a deflector, a compression screw, and a trigger assembly;
wherein at least one of the sprinkler components comprises the corrosion resistant polymer.

22. A nozzle comprising the frame of claim 15, further comprising:
one or more nozzle components attached to the frame, the nozzle components selected from the group Consisting of a strainer, a deflector, a splitter, and a pin;
wherein at least one of the nozzle components comprises the corrosion resistant polymer.

23. The frame of a sprinkler or nozzle of claim 15, wherein the corrosion resistant polymer comprises PTFE.

24. The frame of a sprinkler or nozzle of claim 4, wherein the corrosion resistant metal comprises C22 alloy, and the corrosion resistant alloy comprises at least one of ECTFE or ETFE.
